(19) United States
(12) Patent Application Publication
(10) Pub. No.: US 2006/0099353 A1
(43) Pub. Date: May 11, 2006

(54) Abstract color change pattern configuration

(76) Inventor: Yi-Ching Needham, Taipei County (TW)

Correspondence Address: Yi-Ching NEEDHAM, P.O. Box No. 6-57, Junghe, Taipei, 235, TW

(21) Appl. No.: 10/984,767

(22) Filed: Nov. 10, 2004

(51) Int. Cl. C09K 19/00

(52) U.S. Cl. 428/1.1

(57) ABSTRACT

The present invention provides an abstract color change pattern configuration, which is primarily structured to comprise a transitional layer and a protective layer. The transitional layer is fabricated from a plurality of temperature variant microcapsule liquid crystal materials, wherewith a plurality of mixing layers of color change microcapsule liquid crystal material are able to transform into irregular patterns, and blended colors manifested therefrom are not limited to generating one pattern, but color blending effectuates a plurality of transformations. Such a configuration realizes fabrication of the transitional layer to produce diverse temperature variant transitional abstract patterns according to user requirements.

### BACKGROUND OF THE INVENTION

(a) Field of the Invention

The present invention provides an abstract color change pattern configuration, which is primarily structured to comprise a transitional layer and a protective layer. The transitional layer is fabricated from a plurality of temperature variant microcapsule liquid crystal materials, wherewith a plurality of mixing layers of color change microcapsule liquid crystal material are able to transform into irregular patterns, and blended colors manifested therefrom are not limited to generating one pattern, but color blending effectuates a plurality of transformations. Such a configuration realizes fabrication of the transitional layer to produce diverse temperature variant transitional abstract patterns according to user requirements.

(b) Description of the Prior Art

Referring to FIG. 1, which shows single color color change liquid crystals 3 embedded within a body 1 of a conventional color change decoration item. The color change liquid crystals 3 are covered by means of a protective layer 2, which achieves protection of the color change liquid crystal 3 therewith. Upon a ring 4 of the decoration item being fitted onto a finger of a person or a decoration item of other shapes comes in contact with the body of the person, body temperature of the person produces a color change in the liquid crystal 3. Referring to FIG. 2, the plurality of color change liquid crystals 3 are embedded interior of the body 1 and beneath the protective layer 2. After the color change liquid crystals 3 have solidified, upon encountering a change in temperature, the color change liquid crystals 3 change color, and coming in contact with the body of a person is one example of effectuating a color change upon encountering a temperature change. However, usage of such conventional art can only realize an embedding having a single setting temperature color change, and thus overly monotonous with respect to usage and eye appeal.

Hence, a prospect of the inventor of he present invention is the intention to resolve problem of providing an abstract color change pattern configuration that effectuates a large color change without reduplication of a color change configuration. Accordingly, the inventor of the present invention proposes to resolve and surmount existent technical difficulties in eliminating the aforementioned shortcomings to achieve such.

### SUMMARY OF THE INVENTION

Referring to FIG. 3, which shows the present invention primarily structured to comprise a microcapsule liquid crystal transitional layer and an outer protective layer, therewith enabling setting of different colors and blending of transitional temperature variant color change microcapsule liquid crystals, which are thus made to subsist in the transitional layer. Further referring to FIG. 4, the interior of the transitional layer contains a plurality of mixing layers of color change microcapsule liquid crystal material. The plurality of mixing layers of color change microcapsule liquid crystal material are fabricated from a plurality of color change materials. The plurality of mixing layers of color change microcapsule liquid crystal material embedded in the transitional layer can transform into irregular patterns, and blended colors manifested therefrom are not limited to generating one pattern, but color blending effectuates a plurality of transformations. Such a configuration realizes fabrication of the transitional layer into a required shape according to requirements of a user by matching the plurality of mixing layers of the color change microcapsule liquid crystal material.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional color change layer structure.

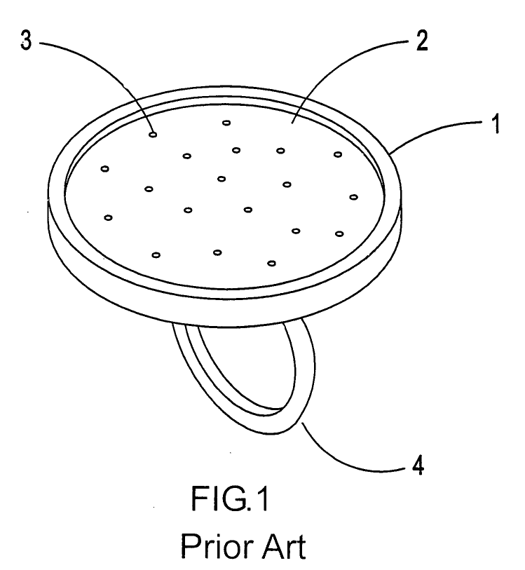

FIG. 2 shows a schematic cross-sectional view of the conventional color change layer structure.

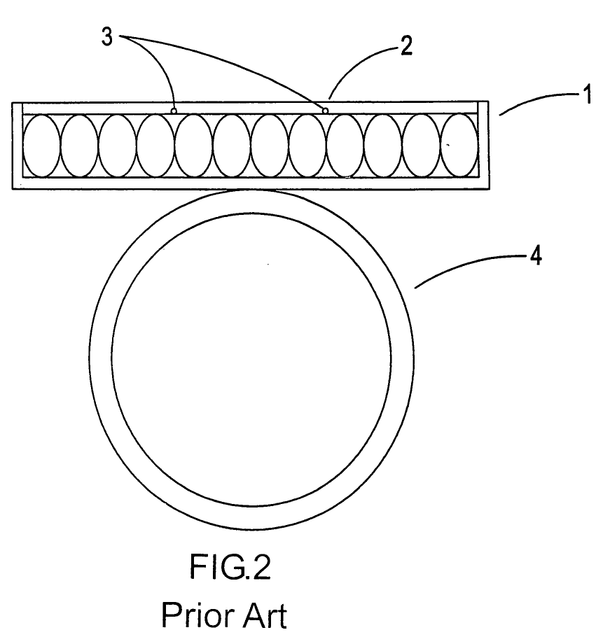

FIG. 3 shows a schematic elevational view according to the present invention.

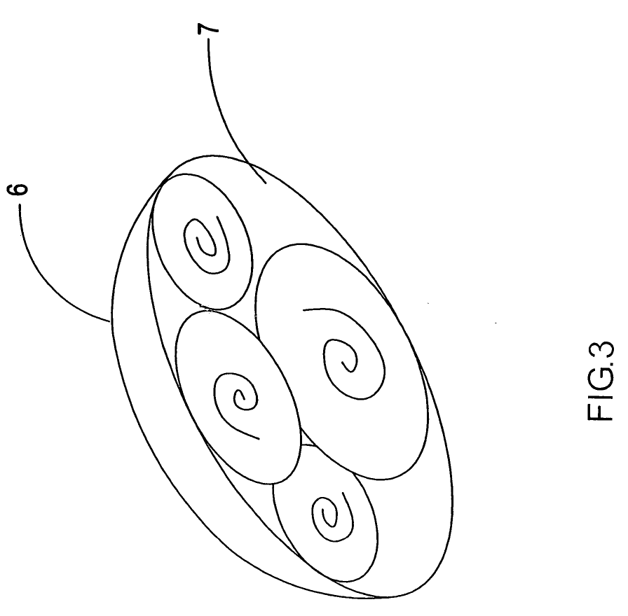

FIG. 4 shows a schematic cross-sectional view according to the present invention.

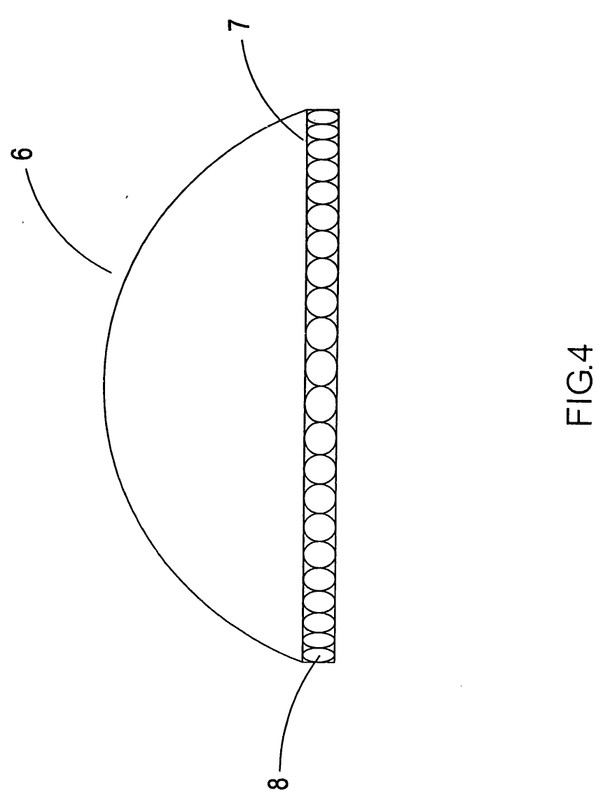

FIG. 5 shows a schematic view depicting usage according to the present invention.

FIG. 6 shows a schematic view depicting another usage according to the present invention.

### DETAILED DESCRIPTION OF THE PREFERRED EMBODIMENTS

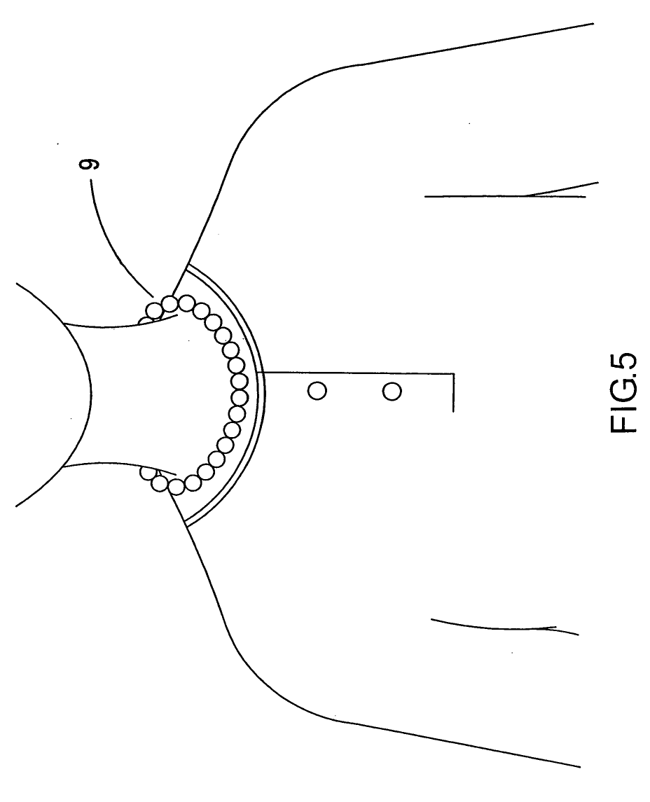

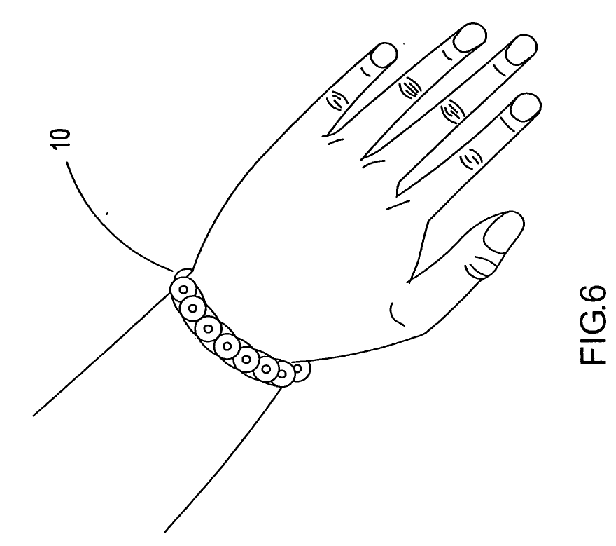

Referring to FIG. 5, which depicts a necklace 9, upon a user placing the necklace 9 round the neck or when the necklace 9 is close to the human body, the necklace 9 responds to local heat energy from body temperature, thereby enabling a transitional layer 7 interior of a configuration to function in coordination with a plurality of mixing layers 8 of color change microcapsule liquid crystal material and produce color transformation thereof, thus achieving objective of abstract color change. Further referring to FIG. 6, the present invention can also be fabricated to produce a bracelet 10, which is worn on the wrist for decorative effect (or other conventional jewelry items, for instance, a ring or a dress accessory, and so on, worn elsewhere on the body), and analogous to the aforementioned necklace 9 can produce transformation in abstract color changes.

In order to better explicitly disclose advancement and practicability of the present invention, a comparison with conventional art is described hereinafter:

Shortcomings of conventional art

1. Only effectuates a single color change, and lacks transformation effectiveness.

2. Over-simplified structure, and inability to add another color.

3. Poor practicability.

4. Restricted usage.

Advantages of the present invention

1. Because of blended structure, ability to produce color transformation.

2. Because of relative advancement in structural configuration, the configuration is easily varied.

3. Embodies advancement.

4. Embodies practicability.

In conclusion, the present invention in surmounting structural shortcomings of prior art has assuredly achieved effectiveness of anticipated advancement, and moreover, is easily understood by persons unfamiliar with related art. Furthermore, contents of the present invention have not been publicly disclosed prior to this application, and advancement and practicability of the present invention comply with essential elements as required for application of a new patent model. Accordingly, a patent application is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An abstract color change pattern configuration, characterized in that: the abstract color change pattern configuration comprises a transitional layer and a protective layer, the transitional layer is fabricated from a plurality of temperature variant microcapsule liquid crystal materials, wherewith a plurality of mixing layers of color change microcapsule liquid crystal material are able to transform into irregular patterns, and blended colors manifested therefrom are not limited to generating one pattern, but color blending effectuates a plurality of transformations; such a configuration realizes fabrication of the transitional layer to produce diverse temperature variant transitional abstract patterns according to user requirements.
